(19) United States
(12) Patent Application Publication
(10) Pub. No.: US 2025/0055729 A1
(43) Pub. Date: Feb. 13, 2025

(54) DELAY-DOPPLER ROBUST OFDM FOR DOUBLY DISPERSIVE WIRELESS CHANNELS

(71) Applicant: ISTANBUL MEDIPOL UNIVERSITESI, Istanbul (TR)

(72) Inventors: Salah Eddine ZEGRAR, Istanbul (TR); Hüseyin ARSLAN, Istanbul (TR)

(21) Appl. No.: 18/718,235

(22) PCT Filed: Dec. 7, 2022
(86) PCT No.: PCT/TR2022/051430

§ 371 Date: Jun. 10, 2024

(30) Foreign Application Priority Data
Dec. 9, 2021 (TR) 2021/019519

(51) Int. Cl. H04L 25/02; H04L 27/26

(52) U.S. Cl. CPC H04L 25/0226; H04L 27/26134

(57) ABSTRACT

A method for designing pilots inserted into orthogonal frequency division multiplexing (OFDM) waveform intended for channel estimation such that the channel can be seen and estimated in both time-frequency and delay-Doppler domains.

### TECHNICAL FIELD

Present invention relates to a new method for designing pilots inserted into orthogonal frequency division multiplexing (OFDM) waveform intended for channel estimation such that the channel can be seen and estimated in both time-frequency and delay-Doppler domains.

The ability of estimating the sparsest channel impulse response will provide easy delay-Doppler estimation and equalization even at very high mobility scenarios. On the other hand, the ability of estimating the channel in time-frequency domain makes the disclosed invention backward compatible with all channel estimation techniques developed for OFDM.

### PRIOR ART

In next generation communication systems, higher data rates and better spectral efficiency are of great importance. Among many multicarrier techniques that support these features, OFDM dominates the current broadband wireless communication systems such as the 5G wireless communication, digital audio and video broadcasting (DAB/DVB), IEEE 802.11a/n/ax/ah/be, and the local area network (LAN).

Wireless communications in high mobility environments have attracted considerable attentions during the past few years, due to the large-scale deployment of high-speed railway (HSR) systems, and the growing popularity of highway vehicular communications systems and low altitude flying object (LAFO) systems. High mobility communications have been incorporated as an integral part of the fifth generation (5G) communications.

A guard interval (cyclic prefix) is inserted in order to combat the frequency-selectivity of the channel that causes inter-symbol interference (ISI). The transmitter and receiver for OFDM can be implemented efficiently by using fast Fourier transform techniques. Increasing the duration of a transmitted symbol, however, makes the system more sensitive to the time-selectivity of the channel. As the time-selectivity affects the orthogonality of the carriers, a larger symbol duration gives rise to more intercarrier interference (ICI). The lengthening of the symbol duration, introduced to combat the frequency-selectivity, therefore is limited by the time-selectivity. In addition, emerging 6G and beyond networks are required to support diverse usage scenarios. A fundamental requirement is multi-user MIMO, which holds the promise of massive increases in mobile broadband spectral efficiency using large numbers of antenna elements at the base-station in combination with advanced precoding techniques. This promise comes at the cost of very complex architectures that cannot practically achieve capacity using traditional OFDM techniques and suffers performance degradation in the presence of time and frequency selectivity. Other important use cases include operation under non-trivial dynamic channel conditions (for example vehicle-to-vehicle and high-speed rail) where adaptation becomes unrealistic, rendering OFDM narrowband waveforms strictly suboptimal.

It is well known that OFDM is capacity-achieving in frequency-selective channels. However, this optimality holds only under a set of very specific assumptions, including (i) knowledge of the channel state information (CSI) at the transmitter, (ii) Gaussian modulation alphabet, (iii) long codewords (which implies the absence of latency constraints), and (iv) unlimited receiver complexity. These assumptions are not fulfilled in many of the 5G applications. It is thus imperative to investigate a novel solution to address these issues. However, even the new developed method could not solve the issues above, and each of these methods came up with it own drawbacks. The methods for fulfilling the assumptions mentioned above has some advantages such as
1. Some of these methods (i) sacrifices the performance in order to estimate and cancel the effect of Doppler.
2. Methods according to (ii) require complex signal processing.
3. Methods according to (iii) are usually unpractical assumptions.
4. In case of methods according to (iv) new waveforms such as OTFS suffer from complex receivers as well as being not backward compatible with older technologies.

### AIM OF THE INVENTION

The present invention aims to present a method for sparse channel representation in delay-Doppler domain.

The present invention also aims to present a method for estimating the wireless channel taps along with their corresponding delay and Doppler shifts.

The inventors also aim to provide a method having backwards compatibility and with simple low-complexity doubly dispersible channel (time and frequency selective channel) equalizer.

### BRIEF DESCRIPTION OF THE INVENTION

The invention is directed to a method for designing pilots inserted orthogonal frequency division multiplexing (OFDM) waveform intended for channel estimation wherein said method comprises the general steps of; (i) waveform generation at the transmitter and (b) estimation and detection at the receiver.

The method of the invention designs pilots such that channel can be seen and estimated in both time-frequency and delay-Doppler domains.

The advantages of the method of invention can be given as follows, it allows for estimating the wireless channel in both time-frequency and delay-Doppler domains. The method of the invention has backward compatibity with OFDM, beacuse only the pilot values are altered. The method of the invention provides linear doubly dispersive channel equalization and robustness in high mobile channels.

The disclosed invention with all of its embodiments makes OFDM waveform robust in doubly dispersive channels (time and frequency selective channels) without changing too much on the general structure of the conventional OFDM, thus it is suitable for all mobility cases in wireless communication. Therefore, the operators will be in need of changing the infrastructure of the already existing technology. By doing so high mobile users will be served with high quality of service such as high-speed railway (HSR) users. Also, the disclosed invention will enable future key technologies for 6G and beyond such as vehicle-to-vehicle (V2V) or vehicle-to-anything (V2X) communication where mobility is always an issue. Last but not least, the invention will also support low altitude flying object (LAFO) systems and non-terrestrial base stations.

### EXPLANATION OF FIGURES

FIG. 1: The OFDM pilot distribution used in time-frequency

FIG. 2: The equivalent representation of the pilots in FIG. 1 in the delay-Doppler domain using the disclosed design

### DETAILED DESCRIPTION OF THE INVENTION

As mentioned above and embodiment of the invention is a method for designing pilots inserted within orthogonal frequency division multiplexing (OFDM) waveform intended for channel estimation wherein said method comprises the general steps of; (i) waveform generation at the transmitter and (ii) estimation and detection at the receiver.

In an embodiment of the invention the step of generation at the transmitter comprises;
Defining the pilot ratio at the beginning,
Choosing the pilots in time-frequency that are equally spaced in frequency and shifting at each time slot,
Choosing the pilots' complex values to provide localization of the representation in the delay-Doppler domain.

In an embodiment of the invention choosing the pilots in time-frequency is carried out by assigning them specific complex values.

The pilot values are assigned in the time-frequency domain so that they show up sparse and localized in delay-Doppler domain. One way of doing that is by backward design where we assign few pilots in delay-Doppler domain and consider their transform to time-frequency as the OFDM pilots.

Further, the communication data will be assigned to the empty grid in the time-frequency domain.

In an embodiment of the invention, the invention relates to a method for designing pilots inserted within orthogonal frequency division multiplexing (OFDM) waveform intended for channel estimation wherein said method comprises the steps of;
(i) Waveform generation at the transmitter comprising the steps of (or which carries out the steps of);
   Defining the pilot ratio at the beginning,
   Choosing the pilots in time-frequency that are equally spaced in frequency and shifting at each time slot,
   Choosing the pilots' complex values to provide localization of the representation in the delay-Doppler domain. and
(ii) estimation and detection at the receiver.

In an embodiment of the invention the step of estimation and detection at the receiver comprises channel estimation and channel equalization

In an embodiment of the invention the channel estimation is carried out by (or comprises the steps of);
Using the pilots directly in time-frequency domain as in conventional schemes preferably for static channels or
Transforming the received pilots' values to delay-Doppler domain to see the sparsest channel impulse preferably for mobile channels.

In an embodiment of the invention the channel equalization is carried out by (or comprises the steps of); transforming the delay-Doppler response to time-frequency and equalize. In a preferred embodiment of the invention the equalization is a linear equalization.

Also, it must be noted that all type of estimators can be used at the receiver.

In an embodiment of the invention the invention is directed to a method for for designing pilots inserted within orthogonal frequency division multiplexing (OFDM) waveform intended for channel estimation wherein said method comprises the steps of;
(i) Waveform generation at the transmitter comprising the steps of (or which carries out the steps of);
   Defining the pilot ratio at the beginning,
   Choosing the pilots in time-frequency that are equally spaced in frequency and shifting at each time slot,
   Choosing the pilots' complex values to provide localization of the representation in the delay-Doppler domain. and
(ii) estimation and detection at the receiver comprising the steps of; channel estimation and channel equalization.

In a preferred embodiment of the invention the invention is directed to a method for for designing pilots inserted within orthogonal frequency division multiplexing (OFDM) waveform intended for channel estimation wherein said method comprises the steps of;
(i) Waveform generation at the transmitter comprising the steps of (or which carries out the steps of);
   Defining the pilot ratio at the beginning,
   Choosing the pilots in time-frequency that are equally spaced in frequency and shifting at each time slot,
   Choosing the pilots' complex values to provide localization of the representation in the delay-Doppler domain. and
(ii) estimation and detection at the receiver comprising the steps of;
   carrying out channel estimation by;
      Using the pilots directly in time-frequency domain as in conventional schemes
      Transforming the received pilots' values to delay-Doppler domain to see the sparsest channel impulse

### And/or

Carrying out the channel equalization by;
   transforming the delay-Doppler response to time-frequency and equalize.

### EXAMPLES

### Example 1

### Application of the Method According to Present Invention

### At the Transmitter Side:

The pilots are carefully chosen in time-frequency domain by assigning them specific complex values so that the equivalent representation of these pilots in delay-Doppler domain is localized in delay-Doppler domain. The following design criteria must be taken into consideration:
First, the pilot ratio is defined at the beginning, this step will affect the range of delays and Dopplers estimated.
The pilots in time-frequency are chosen to be equally spaced in frequency and shifted at each time slot.
The pilots' complex values are chosen to localize the representation in the delay-Doppler domain.

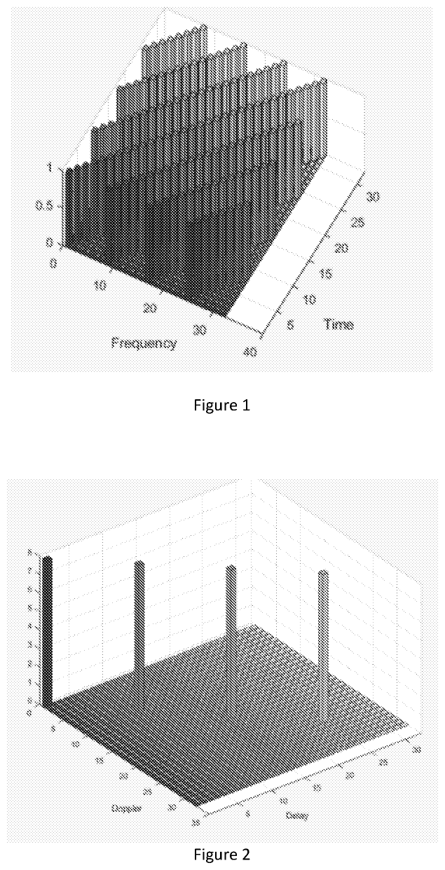

For example as seen in FIG. 1, if the pilots are carefully chosen in time-frequency domain by assigning them specific complex values. The equivalent representation of these pilots in delay-Doppler domain is shown in FIG. 2 where all the pilots in time-frequency become localized in delay-Doppler domain.

The communication data will be assigned to the empty grid in the time-frequency domain.

### At the Receiver Side:

At the receiver side the designed system can used for multiple purposes as follows:

### I—Channel Estimation

At the receiver side the pilots can be directly used in time-frequency domain as in conventional OFDM schemes. Additionally, the invention allows the receiver to see the sparsest channel impulse response by transforming the received pilots' values to delay-Doppler domain. For example, in case of static channels, the receiver would perform conventional channel estimation and equalization. However, in case of mobility, the channel is preferred to be estimated in delay-Doppler domain.

### II—Channel Equalization

Even in the existence of high doppler in the channel, the proposed scheme allows linear equalization, simply by transforming the delay-Doppler response to time-frequency and equalize. Also note, that all type of estimators can be used at the receiver.

### INDUSTRIAL APPLICABILITY OF THE INVENTION

The invention is applicable to industry that is interested in wireless communication. More specifically any wireless communication technology can utilize this invention to provide reliable communication over doubly-dispersive channels using OFDM. Standards like 3GPP-based cellular and IEEE 802.11 based Wi-Fi networks, or any wireless network are particularly relevant to the invention due to the support of multipoint coordination provided in both standards. Furthermore, the described method in this invention can be implemented on any device, system or network capable of supporting any of the aforementioned standards, for instance: code division multiple access (CMDA), frequency division multiple access (FDMA), Global System for Mobile communications (GSM), GSM/General Packet Radio Service (GPRS), Enhanced Data GSM Environment (EDGE), Wideband-CDMA (W-CDMA), Evolution Data Optimized (EV-DO), High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (NR), or other known signals that are used to communicate within a wireless, cellular or internet of things (IoT) network.

Around these basic concepts, it is possible to develop several embodiments regarding the subject matter of the invention; therefore the invention cannot be limited to the examples disclosed herein, and the invention is essentially as defined in the claims. Separate embodiments of the invention can be combined where appropriate.

It is obvious that a person skilled in the art can convey the novelty of the invention using similar embodiments and/or that such embodiments can be applied to other fields similar to those used in the related art. Therefore it is also obvious that these kinds of embodiments are void of the novelty criteria and the criteria of exceeding the known state of the art.

1. A method for designing pilots inserted within orthogonal frequency division multiplexing (OFDM) waveform intended for channel estimation wherein said method comprises the steps of:
waveform generation at the transmitter is carried out by:
defining the pilot ratio at the beginning;
choosing the pilots in time-frequency that are equally spaced in frequency and shifting at each time slot;
choosing the pilots' complex values to provide localization of the representation in the delay-Doppler domain; and
estimation and detection at the receiver.

2. The method of claim 1, wherein the estimation and detection at the receiver comprises channel estimation and channel equalization.

3. The method of claim 2, wherein the channel estimation comprises the steps of:
using the pilots directly in time-frequency domain as in conventional schemes preferably for static channels; or
transforming the received pilots' values to delay-Doppler domain to see the sparsest channel impulse preferably for mobile channels.

4. The method of claim 2, wherein channel equalization comprises transforming the delay-Doppler response to time-frequency and equalize.

5. The method according of claim 1, comprising the steps of:
waveform generation at the transmitter comprising the steps of (or which carries out the steps of):
defining the pilot ratio at the beginning;
choosing the pilots in time-frequency that are equally spaced in frequency and shifting at each time slot;
choosing the pilots' complex values to provide localization of the representation in the delay-Doppler domain; and
estimation and detection at the receiver comprising the steps of; channel estimation and channel equalization.

6. The method according to claim 1, comprising the steps of:
waveform generation at the transmitter comprising the steps of:
defining the pilot ratio at the beginning;
choosing the pilots in time-frequency that are equally spaced in frequency and shifting at each time slot;
choosing the pilots' complex values to provide localization of the representation in the delay-Doppler domain; and and
estimation and detection at the receiver comprising the steps of:
carrying out channel estimation by;
using the pilots directly in time-frequency domain as in conventional schemes;
transforming the received pilots' values to delay-Doppler domain to see the sparsest channel impulse; and/or
carrying out the channel equalization by; transforming the delay-Doppler response to timefrequency and equalize.
